(19) United States
(12) Patent Application Publication
(10) Pub. No.: US 2026/0352666 A1
(43) Pub. Date: Nov. 5, 2026

(54) SYSTEMS AND METHODS FOR DYNAMIC ACCESS PERMISSIONING AND ANOMALISTIC ROLE DETERMINATIONS IN A DISTRIBUTED NETWORK

(71) Applicant: BANK OF AMERICA CORPORATION, Charlotte, NC (US)

(72) Inventor: Arjun Thimmareddy, Charlotte, NC (US)

(73) Assignee: BANK OF AMERICA CORPORATION, Charlotte, NC (US)

(21) Appl. No.: 19/195,376

(22) Filed: Apr. 30, 2025

(51) Int. Cl. H04L 9/40

(52) U.S. Cl. CPC H04L 63/102; H04L 63/1425; H04L 63/20

(57) ABSTRACT

Systems, methods, and computer program products are provided herein for dynamic access permissioning and anomalistic role determinations in a distributed network. An example method receives a request for role assignment for a first role associated with permissioned access to at least a first functionality of the system and determines that the request for role assignment is associated with a first user with respect to the first role. The method further generates an access combination identifier for the first user with respect to the first role. The access combination identifier is indicative of a probabilistic determination of a validity of the first user with respect to the first role based on at least a second user's assignment of the first role. The method further provisions the role assignment for the first user based on the access combination identifier.

### TECHNOLOGICAL FIELD

Example embodiments of the present disclosure relate generally to distributed networks and, more particularly, to systems and methods for dynamic access permissioning and anomalistic role determinations in these network implementations.

### BACKGROUND

Electronic networks formed of distributed components may host, permission access to, or otherwise support interactions with a variety of applications, devices, and/or the like. Users within these systems may be associated various roles that also delineate access to various functionalities provided by these systems. Applicant has identified a number of deficiencies and problems associated with conventional systems and associated methods. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided herein for dynamic access permissioning and anomalistic role determinations in a distributed network. An example system includes at least one non-transitory storage device and at least one processor coupled to the at least one non-transitory storage device. The at least one processor may be configured to receive a request for role assignment where the requested role assignment is for a first role associated with permissioned access to at least a first functionality of the system. The processor may further determine that the request for role assignment is associated with a first user with respect to the first role and generate an access combination identifier for the first user with respect to the first role. The access combination identifier may be indicative of a probabilistic determination of a validity of the first user with respect to the first role based on at least a second user's assignment of the first role. The processor may further provision the role assignment for the first user based on the access combination identifier.

In some embodiments, the first user may be associated with a plurality of first user characteristics, the second user may be associated with a plurality of second user characteristics, and at least one first user characteristic of the first user may match at least one second user characteristic of the second user.

In some embodiments, the second user may be one of a plurality of users each associated with the first role, and the processor may be configured to generate the access combination identifier based on probabilistic determination of the validity of the first user with respect to the first role based on the plurality of users'assignment of the first role.

In some embodiments, the processor may be further configured to compare the access combination identifier with a validity threshold and assign the first role to the first user in response to the request for role assignment in an instance which the access combination identifier satisfies the validity threshold.

In some further embodiments, the processor may be further configured to determine a second role associated with permissioned access to at least a second functionality of the system assigned to the first user and revoke assignment of the first role to the first user.

In some embodiments, the processor may be further configured to compare the access combination identifier with a validity threshold and preclude assignment of the first role to the first user in response to the request for role assignment in an instance which the access combination identifier fails to satisfy the validity threshold.

In some further embodiments, the processor may be further configured to generate a user notification indicative of the preclusion of the assignment of the first role to the first user.

In some embodiments, the processor may be further configured to determine a second role associated with permissioned access to at least a second functionality of the system assigned to the first user and preclude assignment of the first role to the first user.

In another embodiment, a computer program product for dynamic access permissioning and anomalistic role determinations is provided. The computer program product may include a non-transitory computer-readable medium including code that, when executed, causes an apparatus to receive a request for role assignment where the requested role assignment is for a first role associated with permissioned access to at least a first functionality of the apparatus; determine that the request for role assignment is associated with a first user with respect to the first role; generate an access combination identifier for the first user with respect to the first role, wherein the access combination identifier is indicative of a probabilistic determination of a validity of the first user with respect to the first role based on at least a second user's assignment of the first role; and provision the role assignment for the first user based on the access combination identifier.

In another embodiment, a method for dynamic access permissioning and anomalistic role determinations in a distributed network is provided. The method may include receiving a request for role assignment, wherein the requested role assignment is for a first role associated with permissioned access to at least a first functionality of the system; determining that the request for role assignment is associated with a first user with respect to the first role; generating an access combination identifier for the first user with respect to the first role, wherein the access combination identifier is indicative of a probabilistic determination of a validity of the first user with respect to the first role based on at least a second user's assignment of the first role; and provisioning the role assignment for the first user based on the access combination identifier.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for dynamic access permissioning and anomalistic role determinations in a distributed network in a distributed network system in accordance with one or more embodiments of the present disclosure;

FIG. 2 illustrates an example method for dynamic access permissioning and anomalistic role determinations in accordance with one or more embodiments of the present disclosure; and

FIG. 3 illustrates an example method for access combination identifier comparisons in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with or who otherwise interacts with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity. In some embodiments, the “user(s)” described herein may refer to a user, system, device, etc. associated with a third party service provider. By way of a non-limiting example, an example user may have various roles with respect to an entity, such as to permission the user's access with respect to functionalities provided by the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. The present disclosure contemplates that the arrangement, presentation, organization, etc. of the user interfaces described herein may vary based upon the intended application of the system.

As used herein, an “engine” or “module” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (e.g., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer or transmission of data between devices, a system and an application, an accessing of stored data by one or more nodes of a computing cluster, a transmission of a requested task, or the like. As described hereinafter, an “interaction” between the system and one or more applications may be permissioned in that the ability for the system (e.g., one or more devices, subsystems, modules, etc.) to access a particular application may be controlled by permissions issued by this application. In some embodiments as described herein, an interaction may refer to one or more actions by a user to access particular features, applications, functionalities, etc. that may be permissioned or to which the access is otherwise restricted. By way of a non-limiting example, a functionality of the system with which the user interacts may be permissioned by the roles associated with the user, such that an interaction may refer to the request to assign a role to a user to provide access to the functionality of the system.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a criterion, including that a threshold has been met, passed, exceeded, etc.

As described above, electronic networks formed of distributed components may host, permission access to, or otherwise support interactions with a variety of applications, devices, and/or the like. Users within these systems may be associated various roles that also delineate access to various functionalities provided by these systems. By way of example, an example entity may leverage various access control and/or permissions systems that grant and/or revoke roles to different users so that these users may access specific role-limited functionalities of the entity. In conventional systems, however, the assignment of roles to users is often unregulated or otherwise completed via ad hoc review of a particular user without further context as the nature of the user's request, the role(s) required, and/or the functionality attempted to be accessed. As such, conventional systems often unnecessarily jeopardize the security of these entities by incorrectly granting access (e.g., via role assignment) to particular users.

In order to solve the issues associated with these systems, embodiments of the present disclosure provide systems and methods for dynamic access permissioning and anomalistic role determinations in a distributed network. For example, the embodiments described herein may receive a request for role assignment for a first role associated with permissioned access to at least a first functionality of the system that is for a first user. The system may generate an access combination identifier for the first user with respect to the first role that is indicative of a probabilistic determination of a validity of the first user with respect to the first role based on at least a second user's assignment of the first role. For example, the system may analyze user characteristics of the first user (e.g., the user's group, job title, etc.) and identify other users (e.g., at least a second user) that have common or matching user characteristics and are assigned the same role as the request (e.g., the first role). The access combination identifier may determine the likelihood that the request for the first role for the first user is valid in light of the assignment of the first role to other users having matching user characteristics. Various role revocation operations may further be employed so as to iteratively update the roles assigned to users for the system. In doing so, the embodiments of the present disclosure provide new mechanisms for user role assignment and associated access management in distributed network systems that were historically unavailable.

### Example System and Circuitry Components

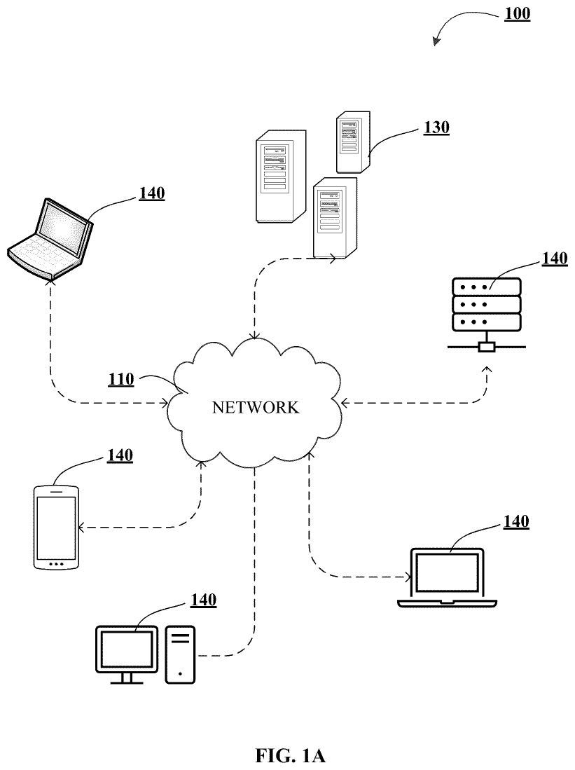

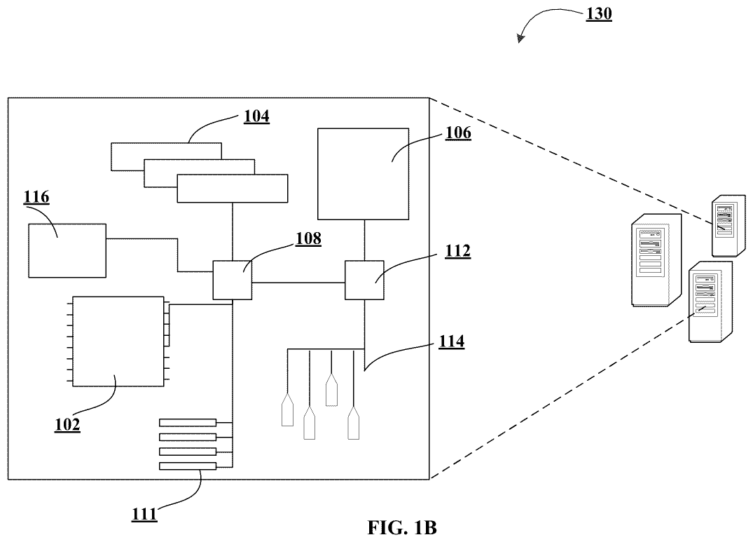

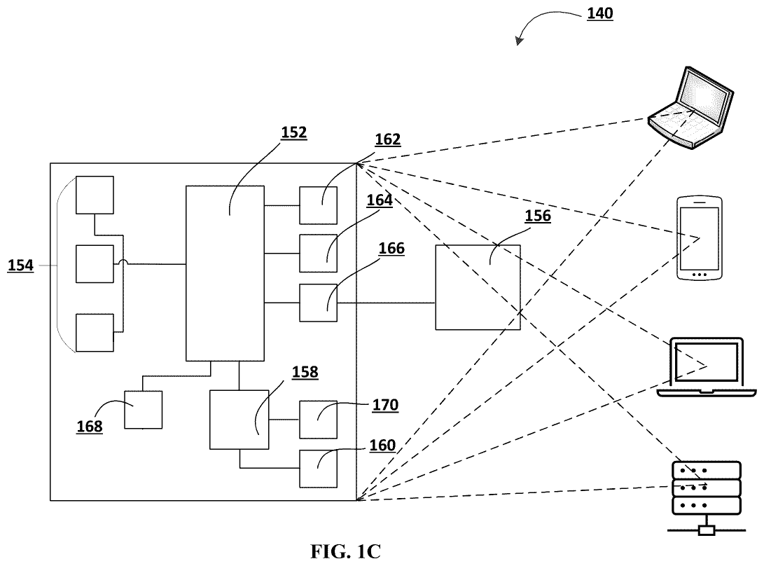

FIGS. 1A-1C illustrate technical components of an exemplary distributed computing environment for dynamic access permissioning and anomalistic role determinations 100, in accordance with one or more embodiments of the present disclosure. As shown in FIG. 1A, the distributed computing environment 100 or distributed network 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the end-point device(s) 140 may define a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and/or a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with one or more embodiments of the present disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a Microdrive or other device, to provide additional storage. Each of the components 152, 154, 158, and 160, are interconnected using various buses, and several of the components may be mounted on a common motherboard or in other manners as appropriate. As described above, the end-point devices 140 described herein may be example devices that are communicable coupled with the system 130 so as to form the distributed network. As such, the system 130 may be communicably coupled with the end-point devices 140 so as to receive transmissions from these devices that may, for example, be used for providing access to the functionalities associated with the system 130.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker. In some embodiments as described herein, the system 130 may leverage role assignment to facilitate user access permissions associated with functionalities of the system 130.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130. Various implementations of the distributed computing environment 100, including the system 130 and end-point device(s) 140, and techniques described here may be realized in digital electronic circuitry, integrated circuitry, specially designed ASICs (application specific integrated circuits), computer hardware, firmware, software, and/or combinations thereof.

### Example Methods for Dynamic Access Permissioning and Anomalistic Role Determinations

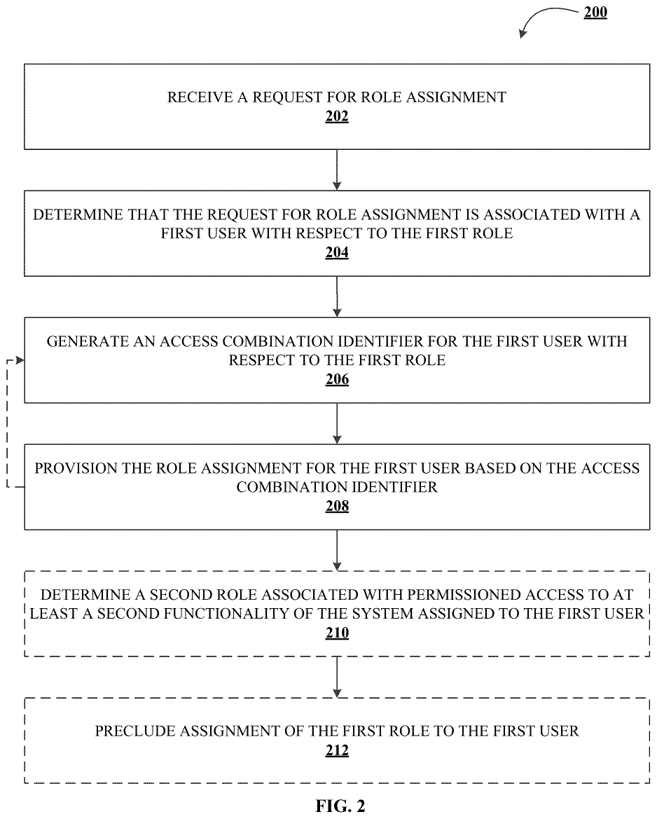

FIG. 2 illustrates a flowchart containing a series of operations for dynamic access permissioning and anomalistic role determinations in a distributed network (e.g., method 200). The operations illustrated in FIG. 2 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1C (e.g., processor 102, processor 152, etc.).

As shown in operation 202, the system 130 may be configured to receive a request for role assignment. As described herein, the requested role assignment may be for a first role associated with permissioned access to at least a first functionality of the system. As described above, the system 130 may be associated with a variety of functionalities, such as applications, systems, sub-systems, databases, etc. that are hosted or otherwise accessible via the system 130. Although described herein with reference to an example application associated with the example functionality of the system 130, the present disclosure contemplates that the system 130 may be associated with any number of functionalities without limitation based on the intended application of the system 130. Furthermore, as described herein, the access to the example first functionality may be such that user's that are assigned the first role have access to the first functionality of the system. The present disclosure contemplates that the functionalities described herein may be multifaceted or multivariate such that, in some embodiments, a plurality of assigned roles are required to access a particular functionality of the system 130.

Thereafter, as shown in operations 204, the system 130 may be configured to determine that the request for role assignment is associated with a first user with respect to the first role. As described above, the system 130 may operate to permissions access to various functionalities of the system by assigning user-specific roles to users that permit or preclude access. As such, the system 130 may determine that the request from operation 202 is associated with a first user before performing the access combination identifier operations described hereinafter. In some embodiments, the system 130 may determine that the request from operation 202 is associated with the first user in response to one or more data entries of the request. For example, the request for role assignment at operation 202 may include data entries that explicitly or implicitly identify the first user. In some embodiments, the request at operation 202 may be received from the first user (e.g., a device associated with the first user), and the system 130 may determine that the request for role assignment is associated with the first user in response. Additionally, the first role may be similarly determined, such as by one or more data entries associated with the request received at operation 202.

Thereafter, as shown in operation 206, the system 130 may be configured to generate an access combination identifier for the first user with respect to the first role. As described herein, the access combination identifier is indicative of a probabilistic determination of a validity of the first user with respect to the first role based on other users that are assigned the first role (e.g., at least a second user's assignment of the first role). In order to identify or otherwise determine other users (e.g., at least a second user) that are also assigned the first role, the system 130 may determine a plurality of first user characteristics. The first user characteristics may refer to any data, attributes, parameters, etc. that define the first user with respect to the system 130. By way of a non-limiting example, the first user characteristics may define the first user's job title, assigned working group, and/or the like. The second user characteristics may refer to any data, attributes, parameters, etc. that define the second user with respect to the system 130. Similarly, the second user characteristics may define the second user's job title, assigned working group, and/or the like.

In order to generate a probabilistic determination that is based on users other than the first user with respect to the first role, the system 130 may determine that at least one first user characteristic of the first user matches at least one second user characteristic of the second user. By way of a non-limiting embodiment, the first user characteristic of the first user may be for a first job title and/or working group that matches the job title and/or working group defined by the second user characteristics of the second user. As would be evident to one of ordinary skill in the art, the second user may be one of a plurality of users and each of the plurality of users may be associated with or assigned the first role. As such, the system 130 may generate the access combination identifier at operation 206 based on probabilistic determination of the validity of the first user with respect to the first role based on the plurality of users'assignments of the first role.

As described above, the access combination identifier may refer to a probabilistic determination of a validity of the first user with respect to the first role. Said differently, the access combination identifier may refer to an indication as to the likelihood that the first user should be assigned the first role based at least in part on the assignment of the first role to a second user that has common or matching user characteristics. In some embodiments, for example, the system 130 may leverage Bayes based probabilistic determinations or Bayesian inferences. By way of a non-limiting example, the system 130 may determine at least a second user for use in the generation of the access combination identifier that is assigned the first role. In such an example, the first user and the second user may also be assigned a base role (e.g., a common role), and the first user may be requesting assignment of the first role. The generation of the access combination identifier may, for example, be determined as the probability of assigning the first role to the first user given the assignment of the base role in which the probability of users in the group (e.g., having matching user characteristics) being assigned the first role multiplied by the probability of users having the base role being assigned the first role. This value is divided by the probability of users having the base role to generate a numerical value that is indicative of the likelihood that the first role should be assigned to the first user (e.g., the likelihood of the validity to the first user with respect to the first role).

As would be evident to one of ordinary skill in the art in light of the present disclosure, the plurality of users having matching user characteristics may be numerous and the roles assigned to each of these users may be similarly numerous. As such, the system 130 may leverage these various data values to provide a numerical or probabilistic value that is indicative of the likelihood that the first user should be assigned the first role. Although described herein with reference to an example Bayesian inference based methodology, the present disclosure contemplates that any method, technique, mechanism, etc. may be used to generate the access combination identifier at operation 206. By way of example, the system 130 may employ various machine learning (ML) models and/or artificial intelligence techniques in order to generate the access combination identifier.

By way of a non-limiting example, a trained ML model used for generation of the access combination identifier may refer to a mathematical model generated by machine learning algorithms based on training data (e.g., operation data from the plurality of disparate privilege access systems) to make predictions or decisions without being explicitly programmed to do so. The example ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The example ML model or algorithm may also refer to programs that are configured to self-adjust and perform better as they are exposed to more data. To this end, the example ML model or algorithm is also capable of adjusting its own parameters, based on previous performance in making prediction about a dataset, such as interaction data for a user.

The example ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The example ML model may be trained using repeated execution cycles of experimentation, testing, and tuning to modify the performance of the ML algorithm and refine the results in preparation for deployment of those results for consumption or decision making. The example ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data.

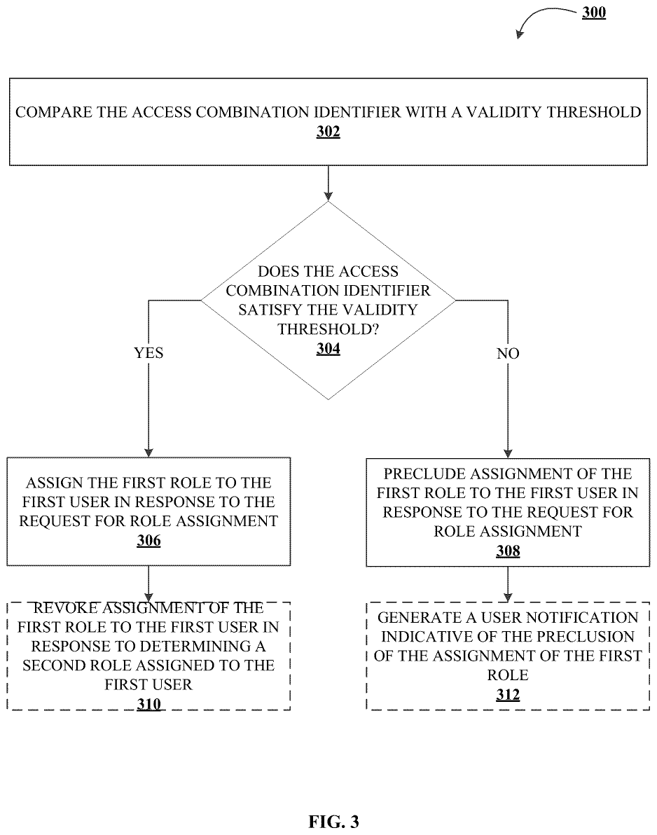

Thereafter, as shown in operation 208, the system 130 may be configured to provision the role assignment for the first user based on the access combination identifier. As described hereinafter with reference to FIG. 3, the system 130 may operate to compare the access combination identifier with one or more thresholds to determine if the likelihood (e.g., the numerical value associated with the probabilistic determination) that the first user should be assigned the first role satisfies such a threshold. If so, the system 130 may operate to assign the first role to the first user. Alternatively, if the access combination identifier fails to satisfy such a threshold, the system 130 may preclude assignment of the first role to the first user. As illustrated in FIG. 2, the system 130 may operate to iteratively perform the generation of the access combination identifier for the first user, so as to account for the dynamic nature of access permissioning. For example, the access combination identifier initially generated at operation 206 may fail to satisfy an applicable threshold. Over time, however additional users within the same group, job title, etc. as the first user may be assigned the first role, and the access combination identifier may be iteratively generated. By way of continued example, the assignment of the first role to various other users with common or matching user characteristics may increase the numerical value of the access combination identifier for the first user such that the value satisfies the applicable thresholds.

In some embodiments, as shown in operations 210 and 212, the system 130 may be configured to determine a second role associated with permissioned access to at least a second functionality of the system assigned to the first user and preclude assignment of the first role to the first user. As would be evident to one of ordinary skill in the art in light of the present disclosure, the roles that permission access in the system 130 may, in some embodiment, be incongruent, incompatible, or otherwise conflicting (e.g., a toxic combination). Said differently, the system 130, in some embodiments, may define various roles, functionalities, etc. that cannot be assigned to the same user (e.g., due to applicable security exposure, regulation, or the like). As such, at operations 210, 212, the system 130 may operate to dynamically and iteratively identify conflicting roles (e.g., the example first and second roles) that may be assigned to the same user and preclude assignment of at least one of these roles to the subject user.

FIG. 3 illustrates a flowchart containing a series of operations for access combination identifier comparisons (e.g., method 300). The operations illustrated in FIG. 3 may, for example, be performed by, with the assistance of, and/or under the control of an apparatus (e.g., system 130, end-point devices 140, etc.), as described above. In this regard, performance of the operations may invoke one or more of the components described above with reference to FIGS. 1A-1C (e.g., processor 102, processor 152, etc.).

As shown in operations 302 and 304, the system 130 may be configured to compare the access combination identifier with a validity threshold and determine if the access combination identifier satisfies the validity threshold. As described above, the access combination threshold may refer to a numerical value that is a probabilistic determination of a validity of the first user with respect to the first role. Said differently, the access combination identifier may refer to an indication as to the likelihood that the first user should be assigned the first role based at least in part on the assignment of the first role to a second user that has common or matching user characteristics. By way of example, in some embodiments, as the numerical value for the access combination identifier increases, the likelihood that the assignment of the first role to the first user is valid similarly increases. Said differently, as the number of other users (e.g., at least a second user) that have matching user characteristics with the first user are assigned the first role, the likelihood that the first user should also be assigned the first role increases, and vice versa. The validity threshold may therefore refer to any value against which the access combination identifier may be compared. By way of a non-limiting example, the generated access combination identifier may be a percentage value (e.g. 75% likelihood) that is compared against a similar percentage value (e.g., validity) threshold (e.g., an 80% threshold) to determine if the access combination identifier satisfies the threshold.

In some embodiments, as shown at operation 306, in an instance which the access combination identifier satisfies the validity threshold (e.g., the numerical values matches or exceeds the numerical value of the threshold), the system 130 may assign the first role to the first user in response to the request for role assignment. In other words, the system 130 may determine that the numerical value of the generated access combination identifier that is indicative of the probabilistic determination of a validity of the first user with respect to the first role by this comparison is satisfactory and assign the first role to the first user. Thereafter, in some embodiments, as shown in operation 310 the system 130 may revoke assignment of the first role to the first user in response to determining a second role assigned to the first user. Similar to operations 210 and 212, the system 130 may operate to dynamically and iteratively identify conflicting roles (e.g., the example first and second roles) that may be assigned to the same user and preclude assignment of at least one of these roles to the subject user.

In other embodiments, as shown in operation 308, in an instance which the access combination identifier fails to satisfy the validity threshold (e.g., the numerical values fails to match or exceed the numerical value of the threshold), the system 130 may preclude assignment of the first role to the first user in response to the request for role assignment. In other words, the system 130 may determine that the numerical value of the generated access combination identifier that is indicative of the probabilistic determination of a validity of the first user with respect to the first role is unsatisfactory by this comparison and preclude assignment of the first role to the first user. Thereafter, in some embodiments, as shown in operation 312 the system 130 may generate a user notification that is indicative of the preclusion of the assignment of the first role to the first user. The user notification may, for example, be provided to a system administrator or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

1. A system for dynamic access permissioning and anomalistic role determinations in a distributed network, the system comprising:
at least one non-transitory storage device; and
at least one processor coupled to the at least one non-transitory storage device, wherein the at least one processor is configured to:
receive a request for role assignment, wherein the requested role assignment is for a first role associated with permissioned access to at least a first functionality of the system;
determine that the request for role assignment is associated with a first user with respect to the first role;
generate an access combination identifier for the first user with respect to the first role, wherein the access combination identifier is indicative of a probabilistic determination of a validity of the first user with respect to the first role based on at least a second user's assignment of the first role; and
provision the role assignment for the first user based on the access combination identifier.

2. The system of claim 1, wherein the first user is associated with a plurality of first user characteristics, the second user is associated with a plurality of second user characteristics, and at least one first user characteristic of the first user matches at least one second user characteristic of the second user.

3. The system of claim 1, wherein the second user is one of a plurality of users each associated with the first role, and the processor is configured to generate the access combination identifier based on probabilistic determination of the validity of the first user with respect to the first role based on the plurality of users'assignments of the first role.

4. The system of claim 1, wherein the processor is further configured to:
compare the access combination identifier with a validity threshold; and
assign the first role to the first user in response to the request for role assignment in an instance which the access combination identifier satisfies the validity threshold.

5. The system of claim 4, wherein the processor is further configured to:
determine a second role associated with permissioned access to at least a second functionality of the system assigned to the first user; and
revoke assignment of the first role to the first user.

6. The system of claim 1, wherein the processor is further configured to:
compare the access combination identifier with a validity threshold; and
preclude assignment of the first role to the first user in response to the request for role assignment in an instance which the access combination identifier fails to satisfy the validity threshold.

7. The system of claim 6, wherein the processor is further configured to generate a user notification indicative of the preclusion of the assignment of the first role to the first user.

8. The system of claim 1, wherein the processor is further configured to:
determine a second role associated with permissioned access to at least a second functionality of the system assigned to the first user; and
preclude assignment of the first role to the first user.

9. A computer program product for dynamic access permissioning and anomalistic role determinations in a distributed network, the computer program product comprising a non-transitory computer-readable medium comprising code that, when executed, causes an apparatus to:
receive a request for role assignment, wherein the requested role assignment is for a first role associated with permissioned access to at least a first functionality of the apparatus;
determine that the request for role assignment is associated with a first user with respect to the first role;
generate an access combination identifier for the first user with respect to the first role, wherein the access combination identifier is indicative of a probabilistic determination of a validity of the first user with respect to the first role based on at least a second user's assignment of the first role; and
provision the role assignment for the first user based on the access combination identifier.

10. The computer program product of claim 9, wherein the first user is associated with a plurality of first user characteristics, the second user is associated with a plurality of second user characteristics, and at least one first user characteristic of the first user matches at least one second user characteristic of the second user.

11. The computer program product of claim 9, wherein the second user is one of a plurality of users each associated with the first role, and the processor is configured to generate the access combination identifier based on probabilistic determination of the validity of the first user with respect to the first role based on the plurality of users'assignment of the first role.

12. The computer program product of claim 9, further comprising code that, when executed, causes the apparatus to:
compare the access combination identifier with a validity threshold; and
assign the first role to the first user in response to the request for role assignment in an instance which the access combination identifier satisfies the validity threshold.

13. The computer program product of claim 12, further comprising code that, when executed, causes the apparatus to:
determine a second role associated with permissioned access to at least a second functionality of the apparatus assigned to the first user; and
revoke assignment of the first role to the first user.

14. The computer program product of claim 9, further comprising code that, when executed, causes the apparatus to:
compare the access combination identifier with a validity threshold; and
preclude assignment of the first role to the first user in response to the request for role assignment in an instance which the access combination identifier fails to satisfy the validity threshold.

15. A method for dynamic access permissioning and anomalistic role determinations in a distributed network, the method comprising:
receiving a request for role assignment, wherein the requested role assignment is for a first role associated with permissioned access to at least a first functionality of the system;
determining that the request for role assignment is associated with a first user with respect to the first role;
generating an access combination identifier for the first user with respect to the first role, wherein the access combination identifier is indicative of a probabilistic determination of a validity of the first user with respect to the first role based on at least a second user's assignment of the first role; and
provisioning the role assignment for the first user based on the access combination identifier.

16. The method of claim 15, wherein the first user is associated with a plurality of first user characteristics, the second user is associated with a plurality of second user characteristics, and at least one first user characteristic of the first user matches at least one second user characteristic of the second user.

17. The method of claim 15, wherein the second user is one of a plurality of users each associated with the first role, and the processor is configured to generate the access combination identifier based on probabilistic determination of the validity of the first user with respect to the first role based on the plurality of users'assignment of the first role.

18. The method of claim 15, further comprising:
comparing the access combination identifier with a validity threshold; and
assigning the first role to the first user in response to the request for role assignment in an instance which the access combination identifier satisfies the validity threshold.

19. The method of claim 18, further comprising:
determining a second role associated with permissioned access to at least a second functionality of the apparatus assigned to the first user; and
revoking assignment of the first role to the first user.

20. The method of claim 15, further comprising:
comparing the access combination identifier with a validity threshold; and
precluding assignment of the first role to the first user in response to the request for role assignment in an instance which the access combination identifier fails to satisfy the validity threshold.
